(19) United States
(12) Patent Application Publication
(10) Pub. No.: US 2015/0036380 A1
(43) Pub. Date: Feb. 5, 2015

(54) LIGHT GUIDE PLATE AND BACKLIGHT MODULE HAVING THE SAME

(71) Applicant: Young Lighting Technology Inc., Hsin-Chu (TW)

(72) Inventor: CHIA-CHUANG HU, Hsin-Chu (TW)

(21) Appl. No.: 14/331,695

(22) Filed: Jul. 15, 2014

(30) Foreign Application Priority Data
Aug. 2, 2013 (CN) 201310334232.6

(51) Int. Cl. F21V 8/00

(52) U.S. Cl. CPC G02B 6/002
USPC 362/608

(57) ABSTRACT

A light guide plate includes a light incident surface, a light emitting surface, a bottom surface, a first lateral surface, and a second lateral surface. The light incident surface has a plurality of elongated optical microstructures, and each elongated optical microstructure has an inclined surface and a curved surface connected with each other. The light guide plate is capable of increasing uniformity and utilization rate of light beam emitting from the light guide plate. A backlight module using the light guide plate is also provided.

### FIELD OF THE INVENTION

The invention relates to a light guide plate, and more particularly to a light guide plate having optical microstructures on its light incident surface, and a backlight module using the light guide plate.

### BACKGROUND OF THE INVENTION

Currently, a light emitting diode (LED) is the mainstream light source for a backlight module. However, since the LED is a point light source, it emits light beam with strong directivity. Therefore, the light beam tends to be focused on a place to generate a local bright spot. A common practice for ameliorating this problem is to form optical microstructures on a light incident surface of a light guide plate of the backlight module. By the optical microstructures, the transmission path of the light beam emitted by the LED may be changed such that the light beam diverges uniformly.

However, although the optical microstructures allow the light beam emitted from the LED to diverge uniformly in the light guide plate, increasing a divergence angle of the light beam incident into the light guide plate results in another problem. That is, it is often unable to meet a total reflection condition when the light beam is incident to a lateral surface of the light guide plate, so that the light beam is emitted to outside of the light guide plate from the lateral surface. This leads to side light leakage.

### SUMMARY OF THE INVENTION

The invention provides a light guide plate, so as to reduce a side light leakage phenomenon and increase light emitting uniformity.

The invention also provides a backlight module having a good light utilization rate and a uniform light emitting effect.

To achieve above at least one of the objects and other advantages, a light guide plate is provided according to an embodiment of the invention. The light guide plate includes a light incident surface, a light emitting surface, a bottom surface opposite to the light emitting surface, a first lateral surface, and a second lateral surface, wherein the light incident surface has a plurality of elongated optical microstructures, each of the elongated optical microstructures has a first end and a second end, the first end is connected to the light emitting surface, the second end is connected to the bottom surface, each of the elongated optical microstructures has an arc-shaped projection on the light incident surface, and each of the elongated optical microstructures has an inclined surface and a curved surface connected with each other.

Further, a backlight module is provided according to an embodiment of the invention. The backlight module includes the above-mentioned light guide plate and at least a light source, wherein the light source is disposed beside the light incident surface of the light guide plate for providing light beam into the light guide plate.

In an embodiment of the invention, the light incident surface of the light guide plate is connected to the first lateral surface and the second lateral surface respectively, wherein the light incident surface has a central axis between the first lateral surface and the second lateral surface, and the central axis is equidistant from the first lateral surface and the second lateral surface. The elongated optical microstructures may include at least a first elongated optical microstructure and at least a second elongated optical microstructure, wherein the first elongated optical microstructure is disposed near the first lateral surface, and the second elongated optical microstructure is disposed near the second lateral surface.

In an embodiment of the invention, the first elongated optical microstructure and the second elongated optical microstructure are mirror symmetric with each other with respect to the central axis.

In an embodiment of the invention, the arc-shaped projection of each elongated optical microstructure on the light incident surface has a curvature radius which is greater than or equal to a thickness of the light guide plate.

In an embodiment of the invention, the arc-shaped projection of the first elongated optical microstructure on the light incident surface has a first curvature center, and the first elongated optical microstructure is located between the first curvature center and the first lateral surface.

In an embodiment of the invention, the arc-shaped projection of the second elongated optical microstructure on the light incident surface has a second curvature center, and the second elongated optical microstructure is located between the second curvature center and the second lateral surface.

In an embodiment of the invention, the arc-shaped projection of the first elongated optical microstructure on the light incident surface has a first curvature center, and the first elongated optical microstructure is located between the first curvature center and the second lateral surface.

In an embodiment of the invention, the arc-shaped projection of the second elongated optical microstructure on the light incident surface has a second curvature center, and the second elongated optical microstructure is located between the second curvature center and the first lateral surface.

In an embodiment of the invention, the light incident surface further includes a plurality of light-diffusing microstructures disposed between the first elongated optical microstructures and the second elongated optical microstructures, and each light-diffusing microstructure is semi-cylindrical shaped and has a semi-cylindrical surface.

In an embodiment of the invention, the semi-cylindrical surface of each light-diffusing microstructure protrudes from the light guide plate with respect to the light incident surface.

In an embodiment of the invention, the semi-cylindrical surface of each light-diffusing microstructure is recessed in the light guide plate with respect to the light incident surface.

In an embodiment of the invention, the inclined surface of the first elongated optical microstructure has a normal line direction exiting the inclined surface away from the first lateral surface.

In an embodiment of the invention, the inclined surface of the second elongated optical microstructure has a normal line direction exiting the inclined surface away from the second lateral surface.

In an embodiment of the invention, the curved surface of each elongated optical microstructure protrudes from the light guide plate with respect to the light incident surface.

In an embodiment of the invention, the curved surface of each elongated optical microstructure is recessed in the light guide plate with respect to the light incident surface.

In an embodiment of the invention, the light guide plate further includes a plurality of light guide microstructures disposed on the bottom surface, the light guide microstructures are in a configuration of V-shaped grooves, semi-cylindrical grooves, spherical depressions, pyramidal depressions, printed dots or a combination of the above configurations.

In an embodiment of the invention, the light incident surface includes a bisector located between the light emitting surface and the bottom surface, the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center coincides with the bisector.

In an embodiment of the invention, the light incident surface includes a bisector located between the light emitting surface and the bottom surface, the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center does not coincide with the bisector.

According to the above descriptions, the light incident surface of the light guide plate of the invention is disposed with the elongated optical microstructures, and each of the elongated optical microstructures has an inclined surface and a curved surface at the same time. The inclined surface of the elongated optical microstructure can reduce a divergence angle of the light beam toward the lateral surface of the light guide plate to satisfy the total reflection condition, such that the light beam can be reflected back inside the light guide plate, and thus side light leakage can be reduced. On the other hand, the curved surface of the elongated optical microstructure can enlarge a divergence angle of the light beam toward the center of the light guide plate, so that the light beam can be uniformly transmitted inside the light guide plate, and thus the generation of hot spots can be reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1A is a schematic three-dimensional view showing a light guide plate according to one embodiment of the invention;

FIG. 1B is a top view schematic diagram showing the light guide plate shown in FIG. 1A;

FIG. 2 is a schematic three-dimensional view showing a backlight module according to another embodiment of the invention;

FIG. 3A is a top view schematic diagram showing a light guide plate without optical micro structures;

FIG. 3B is a top view schematic diagram showing a light guide plate disposed with existing semi-cylindrical optical microstructures;

FIG. 3C is a top view schematic diagram showing a light guide plate disposed with elongated optical microstructures according to the invention;

FIG. 4A is a chart showing optical energy distribution curves measured at positions of the light incident surfaces of the light guide plates near the lateral surfaces, wherein the light guide plates are without optical microstructures, with existing semi-cylindrical optical microstructures, and with elongated optical microstructures of the invention respectively;

FIG. 4B is a chart showing optical energy distribution curves measured at positions of the lateral surfaces of the light guide plates near the light incident surfaces, wherein the light guide plates are without optical microstructures, with existing semi-cylindrical optical microstructures, and with elongated optical microstructures of the invention respectively;

FIG. 5A is a side view schematic diagram showing the light incident surface of the light guide plate of FIG. 1;

FIG. 5B is a side view schematic diagram showing a light incident surface of a light guide plate according to another embodiment of the invention;

FIG. 5C is a side view schematic diagram showing a light incident surface of a light guide plate according to another embodiment of the invention;

FIG. 5D is a side view schematic diagram showing a light incident surface of a light guide plate according to another embodiment of the invention;

FIG. 6 is a top view schematic diagram showing a backlight module according to another embodiment of the invention;

FIG. 7 is a partial top view schematic diagram showing a backlight module according to another embodiment of the invention; and

FIG. 8 is a top view schematic diagram showing a backlight module according to another embodiment of the invention.

### DETAILED DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

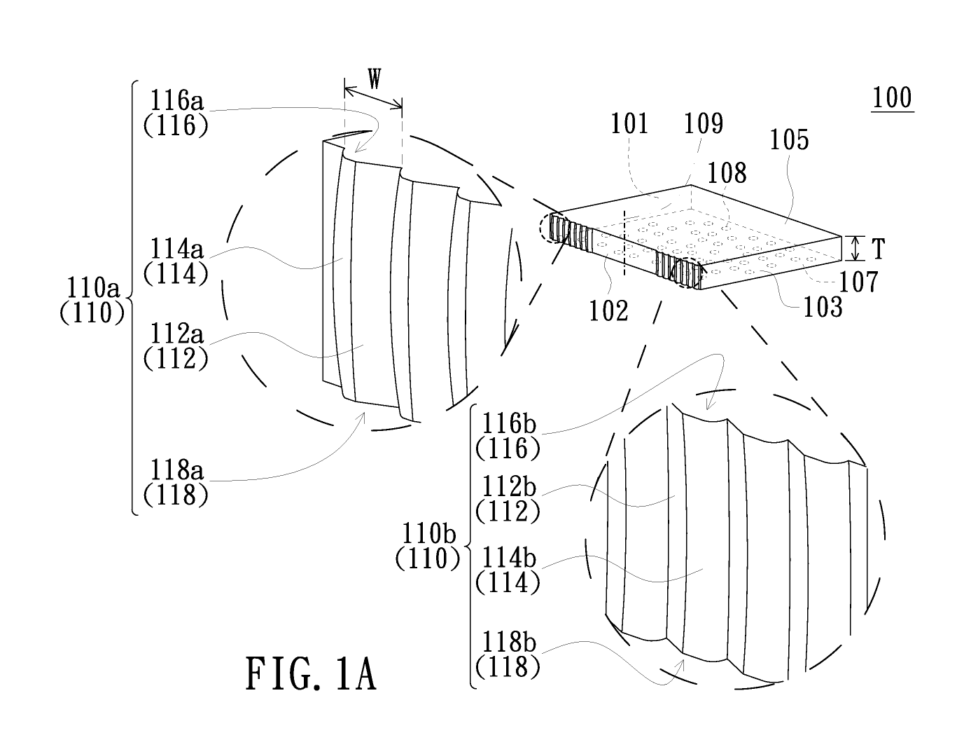

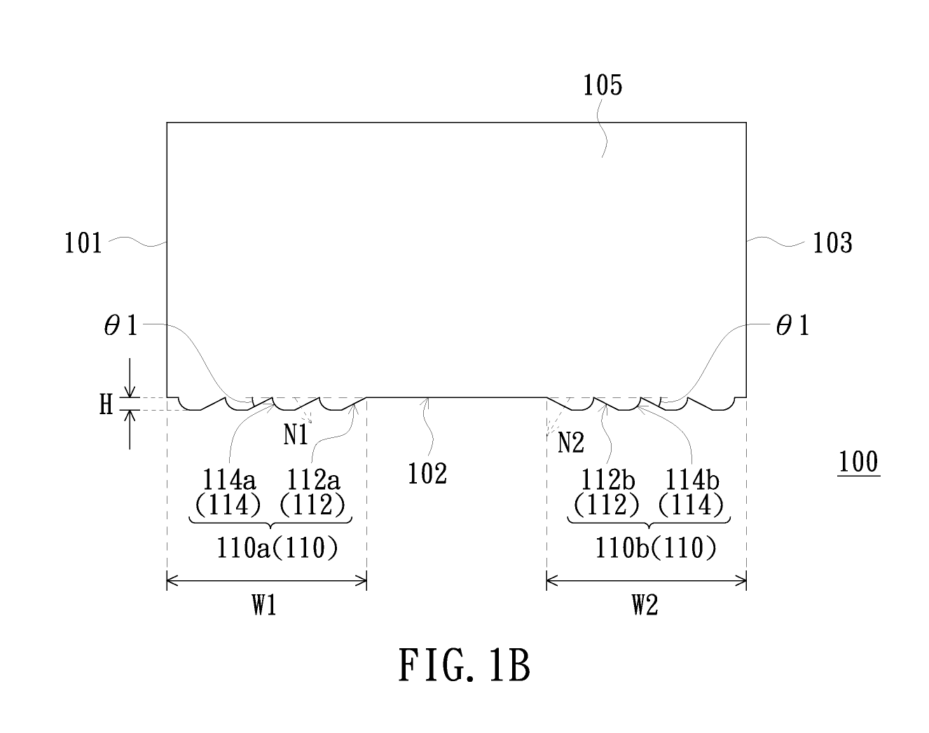

FIG. 1A is a schematic three-dimensional view showing a light guide plate according to one embodiment of the invention, while FIG. 1B is a top view schematic diagram showing the light guide plate shown in FIG. 1A. Referring to FIGS. 1A and 1B, a light guide plate 100 has a light incident surface 102, a first lateral surface 101, a second lateral surface 103, a light emitting surface 105, and a bottom surface 107 opposite to the light emitting surface 105. The light incident surface 102 is connected to the first lateral surface 101 and the second lateral surface 103 respectively. The light incident surface 102 has a plurality of elongated optical microstructures 110, each of the elongated optical microstructures 110 has a first end 116 and a second end 118, wherein the first end 116 is connected to the light emitting surface 105, and the second end 118 is connected to the bottom surface 107. Each of the elongated optical microstructures 110 has an inclined surface 112 and a curved surface 114 connected with each other. In details, the elongated optical microstructures 110 according to this embodiment include a plurality of first elongated optical microstructures 110a and a plurality of second elongated optical microstructures 110b, wherein the first elongated optical microstructures 110a are disposed near the first lateral surface 101, and the second elongated optical microstructures 110b are disposed near the second lateral surface 103. Moreover, the light incident surface 102 has a central axis 109 between the first lateral surface 101 and the second lateral surface 103, and the central axis 109 is equidistant from the first lateral surface 101 and the second lateral surface 103. The first elongated optical microstructures 110a and the second elongated optical microstructures 110b may, but not limited to, be mirror symmetric with each other with respect to the central axis 109 so as to obtain a more uniform light distribution.

It should be noted that the width W and length H of each elongated optical microstructure 110 according to this embodiment are, for example, micrometer (μm) size, and the thickness T of the light guide plate is, for example, millimeter (mm) size. However, an enlarged scale on each dimension is not the same in FIGS. 1A and 1B so as to clearly show the first elongated optical microstructures 110a and the second elongated optical microstructures 110b according to this embodiment. In other words, the size ratio of the light guide plate 100 of this embodiment is not limited to what shown in FIGS. 1A and 1B as they are only schematic diagrams. Moreover, in another embodiment, the number of the first elongated optical microstructure 110a and number of the second elongated optical microstructure 110b can be one respectively.

Moreover, the bottom surface 107 of the light guide plate 100 can have, for example, a plurality of light guide microstructures 108 for guiding light beam incident to the bottom surface 107 to leave the light guide plate 100 from the light emitting surface 105. The light guide microstructures 108 may be, but not limited to, V-shaped grooves, semi-cylindrical grooves, spherical depressions, pyramidal depressions, printed dots or a combination of the above-mentioned configurations.

Continuously referring to FIGS. 1A and 1B, in this embodiment, each of the curved surfaces 114a, 114b of the elongated optical microstructures 110a, 110b is, for example, a convex surface protruding from the light guide plate 100 with respect to the light incident surface 102. The included angle θ1 between each of the inclined surfaces 112a, 112b of the elongated optical microstructures 110a, 110b and the light incident surface 102 within the light guide plate 100 is, for example, smaller than 45°, and preferably between 10° and 20°. Further, the inclined surface 112a of the first elongated optical microstructure 110a has a normal line direction N1 exiting the inclined surface 112a away from the first lateral surface 101, and the inclined surface 112b of the second elongated optical microstructure 110b has a normal line direction N2 exiting the inclined surface 112b away from the second lateral surface 103. Moreover, a distributed width W1 of the first elongated optical microstructures 110a on the light incident surface 102 and a distributed width W2 of the second elongated optical microstructures 110b on the light incident surface 102 may be determined in consideration of positions prone to side light leakage in the existing backlight module. In general, the distributed widths W1 and W2 are smaller than or equal to one half of the total width of the light incident surface 102 in the light guide plate 100. The distributed width W1 may be equal to or not equal to the distributed width W2, the invention does not limit this.

The elongated optical microstructures 110 are preferably arranged without any interval. That is, each inclined surface 112 may, but not limited to, be connected between adjacent two curved surfaces 114. In another embodiment, an interval may be arranged between the elongated optical microstructures 110. On the other hand, the curved surface 114 may be, but not limited to, a circular arc, a paraboloid, an ellipsoid, or any other curved surface that is capable of enlarging the refraction angle of light beam incident into the light guide plate 100 via the curved surface 114, or a combination of the above-mentioned configurations.

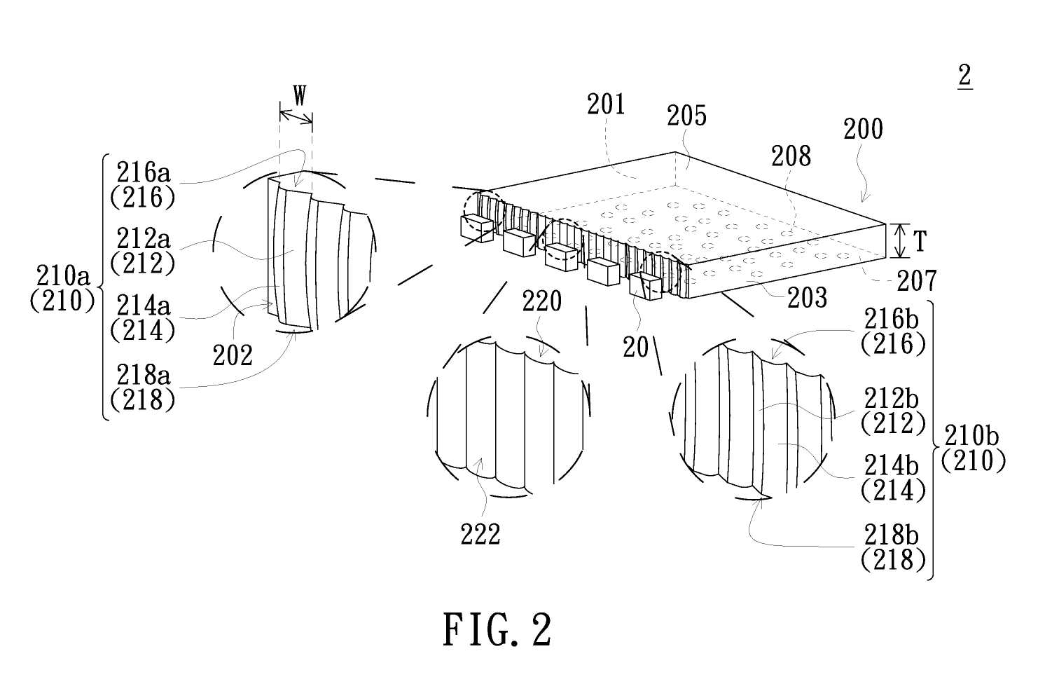

FIG. 2 is a schematic three-dimensional view showing a backlight module 2 according to another embodiment of the invention. Referring to FIG. 2, the backlight module 2 includes at least a light source 20 and a light guide plate 200. The light source 20 is disposed beside a light incident surface 202 of the light guide plate 200. The light source 20 may be, for example, an LED or other point light source. Elongated optical microstructures 210 including first elongated optical microstructures 210a and second elongated optical microstructures 210b are disposed on the light incident surface 202 of the light guide plate 200. The position for disposing the first and second elongated optical microstructures 210a, 210b can be determined in consideration of the positions prone to side light leakage in the existing backlight module. The light guide plate 200 is similar to the aforementioned light guide plate 100. However, in this embodiment, the light incident surface 202 of the light guide plate 200 has a plurality of light-diffusing microstructures 220 disposed between the first elongated optical microstructures 210a and the second elongated optical microstructures 210b. Each light-diffusing microstructure 220 is semi-cylindrical shaped and has a semi-cylindrical surface 222. The semi-cylindrical surface 222 may protrude from the light guide plate 200 with respect to the light incident surface 202. The semi-cylindrical surface 222 is capable of increasing the diffusion angle of the light beam incident into the light guide plate 200 via the light-diffusing microstructure 220 so as to reduce the generation of hot spots. In another embodiment, the semi-cylindrical surface 222 may be recessed in the light guide plate 200 with respect to the light incident surface 202. Moreover, since the light beam incident to the light guide plate 200 via the light-diffusing microstructures 220 has a larger diffusion angle, the light-diffusing microstructures 220 can be disposed apart from a first lateral surface 201 and a second lateral surface 203 at an appropriate distance so as to prevent the side light leakage due to the light beam being emitted to outside of the light guide plate 200 from the first lateral surface 201 or the second lateral surface 203. That is, a path length of the light beam from the light-diffusing microstructures 220 to the first lateral surface 201 or the second lateral surface 203 can be increased such that energy of the light beam being emitted to outside of the light guide plate 200 via the light-diffusing microstructures 220 can be reduced.

The transmission path of the light beam incident to the light guide plate according to the invention will be described hereinafter such that those ordinarily skilled in the art can understand more about characteristics of the light guide plate of the invention.

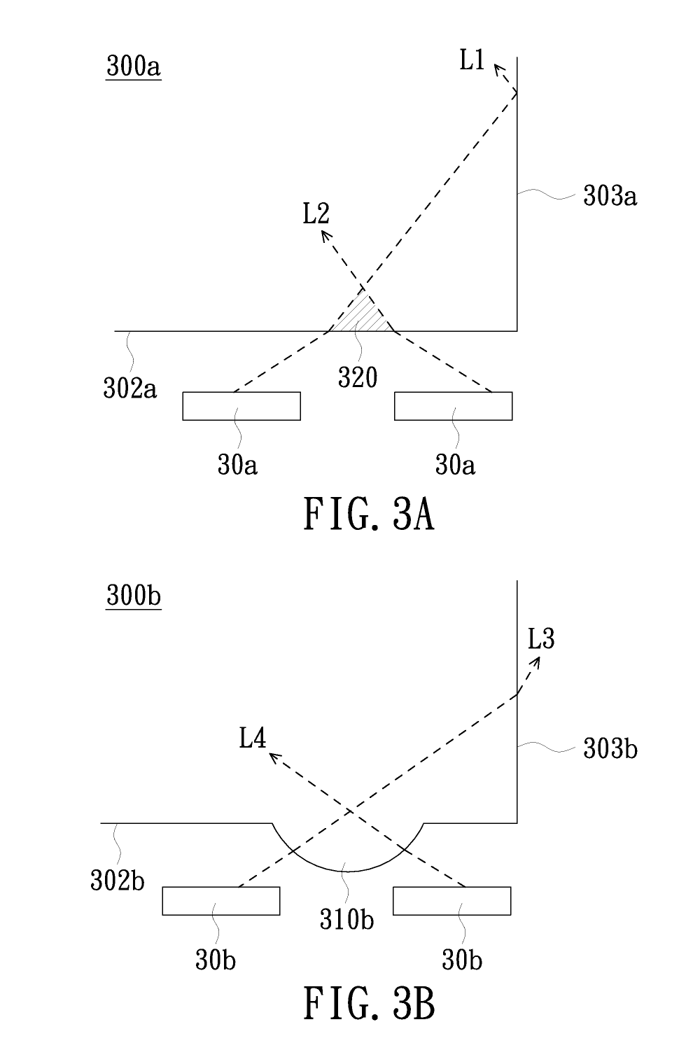

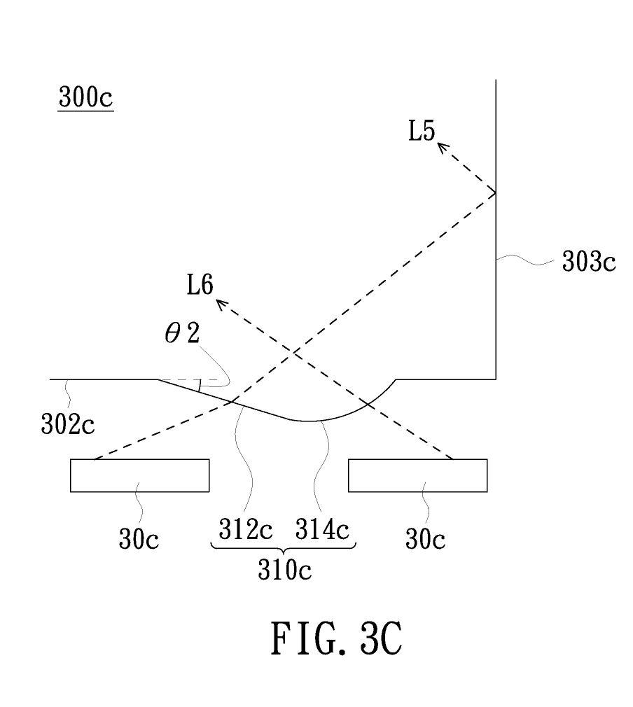

FIGS. 3A to 3C are schematic diagrams showing transmission paths of light beams entering a light incident surface 302a, 302b, or 302c of a light guide plate 300a, 300b, or 300c respectively, wherein the light guide plates 300a, 300b, 300c are of the same size. The light guide plate 300a shown in FIG. 3A is without any optical microstructure on the light incident surface 302a, while FIGS. 3B and 3C respectively are top view schematic diagrams showing light guide plates with existing semi-cylindrical optical microstructures and elongated optical microstructures of the invention disposed on the light incident surfaces respectively. However, for convenience of description, the light guide plate 300b and the light guide plate 300c are shown in FIGS. 3B and 3C with only a single semi-cylindrical optical microstructure 310b and a single elongated optical microstructure 310c of the invention respectively, such that the transmission paths of the light beams can be compared. Light sources 30a, 30b, 30c are disposed beside the light incident surfaces 302a, 302b, 302c of the light guide plates 300a, 300b, 300c respectively. The light sources 30a, 30b, 30c may be LEDs. The intervals between the light sources 30a, 30b, 30c are the same. The optical microstructures 310b, 310c are disposed on the light incident surfaces 302b, 302c of the light guide plates 300b, 300c, respectively.

First, referring to FIG. 3A, which is a schematic diagram showing transmission paths of light beams L1, L2 emitted from the light source 30a passing through the light incident surface 302a. When the light beam L1 is incident to the light incident surface 302a of the light guide plate 300a, the light beam L1 will be deflected by the light guide plate 300a such that the light beam L1 will enter the light guide plate 300a, transmit to a lateral surface 303a of the light guide plate 300a at a total reflection critical angle of the light guide plate 300a, and be reflected back inside the light guide plate 300a. On the other hand, when the light beam L2 is incident to the light incident surface 302a of the light guide plate 300a, the light beam L2 will also be deflected by the light guide plate 300a, and therefore a dark area 320 will be formed between the light beams L1, L2 and the light incident surface 302a.

Next, referring to FIG. 3B, which is a schematic diagram showing transmission paths of light beams L3, L4 emitted from the light source 30b passing through the existing semi-cylindrical optical microstructure 310b. When the light beam L4 is incident to the light incident surface 302b of the light guide plate 300b, the light beam L4 entering the light guide plate 300b will be deflected only marginally as affected by the semi-cylindrical optical microstructure 310b, thereby reducing the generation of hot spots. On the other hand, when the light beam L3 is incident to the light incident surface 302b of the light guide plate 300b, the light beam L3 entering the light guide plate 300b will also be deflected marginally as affected by the semi-cylindrical optical microstructure 310b. Therefore, when the light beam L3 enters the light guide plate 300b and transmits to a lateral surface 303b of the light guide plate 300b, since the light beam L3 entering the light guide plate 300b is only deflected marginally, the light beam L3 cannot satisfy a total reflection condition, and finally will escape out the light guide plate 300b from the lateral surface 303b.

Then, referring to FIG. 3C, which is a schematic diagram showing transmission paths of light beams L5, L6 emitted from the light source 30c passing through the elongated optical microstructure 310c of the invention. An included angle θ2 is formed between an inclined surface 312c of the elongated optical microstructure 310c and the light incident surface 302c. When the light beam L5 emitted from the light source 30c enters the light guide plate 300c from the inclined surface 312c of the elongated optical microstructure 310c, the light beam L5 will be deflected by the inclined surface 312c. Therefore, when the light beam L5 enters the light guide plate 300c and transmits to a lateral surface 303c of the light guide plate 300c, the light beam L5 satisfies a total reflection condition such that the light beam L5 will be reflected back inside the light guide plate 300c by the lateral surface 303c. This can effectively reduce the side light leakage phenomenon caused by the light beam L5 escaping out from the lateral surface 303c. The included angle θ2 is, for example, smaller than 45°, and preferably between 10° to 20°.

Continuously referring to FIG. 3C, comparing to the light beam L5 incident to the inclined surface 312c, the light beam L6 is incident to the light guide plate 300c from a curved surface 314c of the elongated optical microstructure 310c. After the light beam L6 entering the light guide plate 300c, the refraction angle affected by the curved surface 314c is close to the incident angle of the light beam L6. Therefore, a divergence angle of the light beam L6 incident to the light guide plate 300c can be effectively increased by the curved surface 314c. Also, since the included angle θ2 is formed between the inclined surface 312c and the light incident surface 302c, a deflection angle of the light beam L5 incident to the light guide plate 300c will not be too large, and thus a dark area will not be formed between the light beams L5, L6 and the light incident surface 302c.

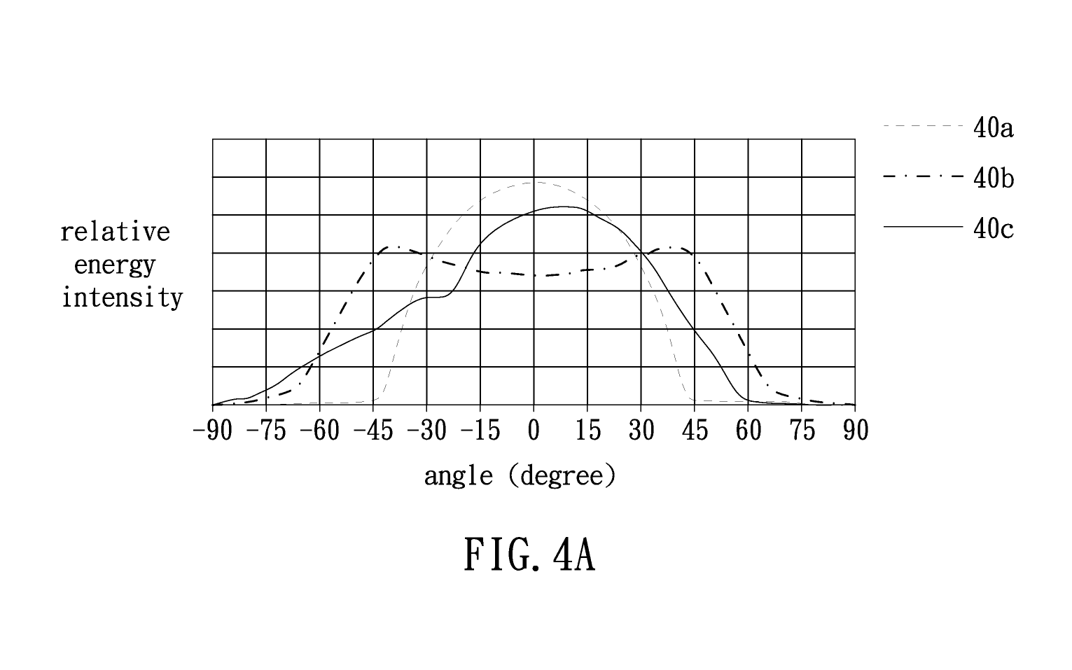

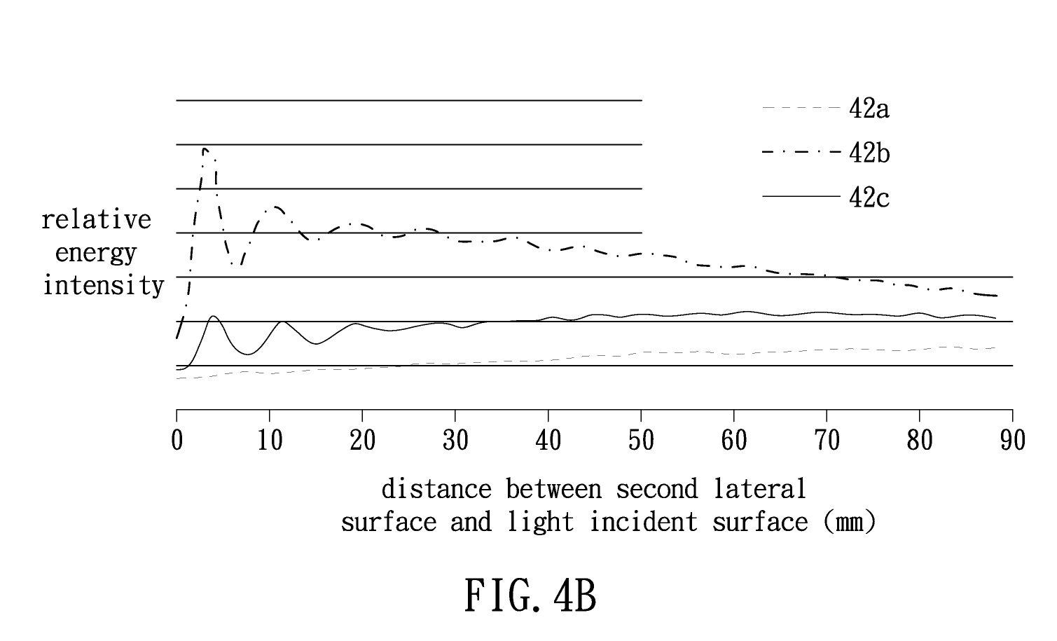

FIG. 4A is a chart showing optical energy distribution curves measured at the same positions of the light incident surfaces 302a, 302b, 302c of the light guide plates 300a, 300b, 300c, wherein the positions are where the optical microstructures disposed as shown in FIGS. 3B and 3C. In FIG. 4A, a curve 40a is an optical energy distribution curve of the light beam incident to the light guide plate 300a without any optical microstructures as shown in FIG. 3A, a curve 40b is an optical energy distribution curve of the light beam incident to the light guide plate 300b having the semi-cylindrical optical microstructures 310b as shown in FIG. 3B, and a curve 40c is an optical energy distribution curve of the light beam incident to the light guide plate 300c having the elongated optical microstructures 310c of the invention as shown in FIG. 3C.

Referring to FIG. 4A, as shown by the curve 40a and FIG. 3A, after the light beam emitted from the light source has passed the light incident surface without any microstructures, the energy of the light beam is concentrated in front of the light source because the incident light beam would be refracted by the light guide plate. This results in a decreased divergence angle of about 45°, and therefore hot spots would be formed easily. As shown by the curve 40b and FIG. 3B, the divergence angle of the light beam passing the semi-cylindrical optical microstructure 310b is enlarged, and thus the generation of hot spots can be reduced. However, since the incident angle of the light beam toward the lateral surface 303b is also increased after the light beam has passed the semi-cylindrical optical microstructure 310b, the light beam transmitting toward the lateral surface 303b of the light guide plate cannot satisfy the total reflection condition, and finally will escape out the light guide plate 300b from the lateral surface 303b, which leads to a side light leakage phenomenon.

Next, referring to the curve 40c and FIG. 3C, when the light beam entering the light guide plate via the inclined surface 312c of the elongated optical microstructures 310c of the invention, since the incident angle of the light beam toward the lateral surface 303c of the light guide plate 300c can be reduced by the inclined surface 312c of the elongated optical microstructures 310c, the light beam satisfies the total reflection condition and will be reflected back inside the light guide plate 300c from the lateral surface 303c of the light guide plate 300c. Therefore, as shown by the curve 40c, the energy of the light beam with an included angle greater than 60° with a normal line of the light incident surface has been largely reduced when comparing to the curve 40b. On the other hand, when the light beam enters the light guide plate 300c via the curved surface 314c of the elongated optical microstructures 310c, since the divergence angle of the light beam entering the light guide plate 300c can be increased by the curved surface 314c of the elongated optical microstructures 310c, the energy of the light beam at an angle of −60° as shown by the curve 40c is close to what shown by the curve 40b. Therefore, the generation of hot spots can be effectively reduced.

FIG. 4B is a chart showing optical energy distribution curves measured at positions of the lateral surfaces 303a, 303b, 303c of the light guide plates as shown in FIGS. 3A to 3C. In FIG. 4B, the abscissa shows distances between the lateral surface 303a and the light incident surface 302a, between the lateral surface 303b and the light incident surface 302b, and between the lateral surface 303c and the light incident surface 302c. The curve 42a is an optical energy distribution curve of the light beam entering the light guide plate from the light incident surface without any optical microstructures, the curve 42b is an optical energy distribution curve of the light beam entering the light guide plate 300b from the semi-cylindrical optical microstructure 310b as shown in FIG. 3B, and the curve 42c is an optical energy distribution curve of the light beam entering the light guide plate 300c from the elongated optical microstructure 310c of the invention as shown in FIG. 3C. Referring to FIGS. 3A to 3C and 4B at the same time, after the light beam enters the light guide plates 300a, 300b, 300c via light incident surfaces 302a, 302b, 302c with three different configurations respectively, the curve 42b shows the highest optical energy and the curve 42a shows the lowest optical energy among optical energy detected at the lateral surfaces 303a, 303b, 303c. This indicates that the semi-cylindrical optical microstructures 310b cause the side light leakage phenomenon by a large amount of incident light beam escaping out the light guide plate 300b. Also, in the case of the light guide plate 300a without any optical microstructure, since the deflection angle of light beam passing the light incident surface 302a becomes larger, the side light leakage phenomenon becomes the least significant. Although the optical energy as shown by the curve 42c concerning the elongated optical microstructures 310c of the invention is higher than what shown by the curve 42a, the light beam escaping out the light guide plate 300c from the lateral surface 303c is effectively reduced when comparing to the curve 42b. Therefore, disposing the elongated optical microstructures of the invention on the light incident surface of the light guide plate can effectively reduce the generation of hot spots when comparing to the light incident surface without any optical microstructure. Also, the side light leakage phenomenon is reduced because the light beam escaping out the light guide plate can be effectively prevented when comparing to the light incident surface disposed with semi-cylindrical optical microstructures.

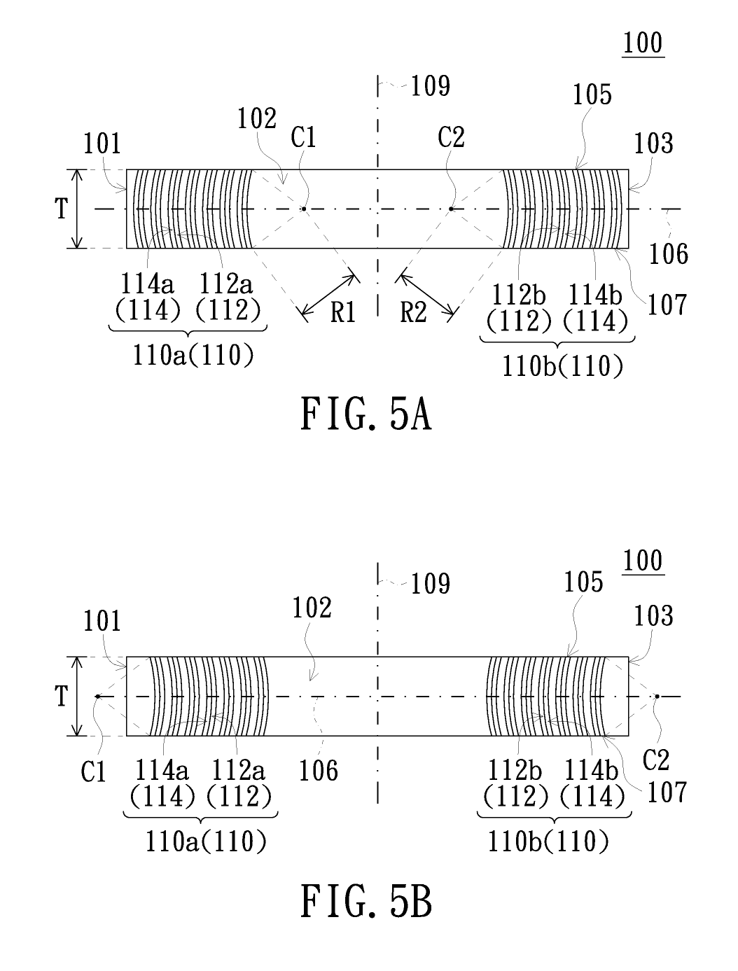

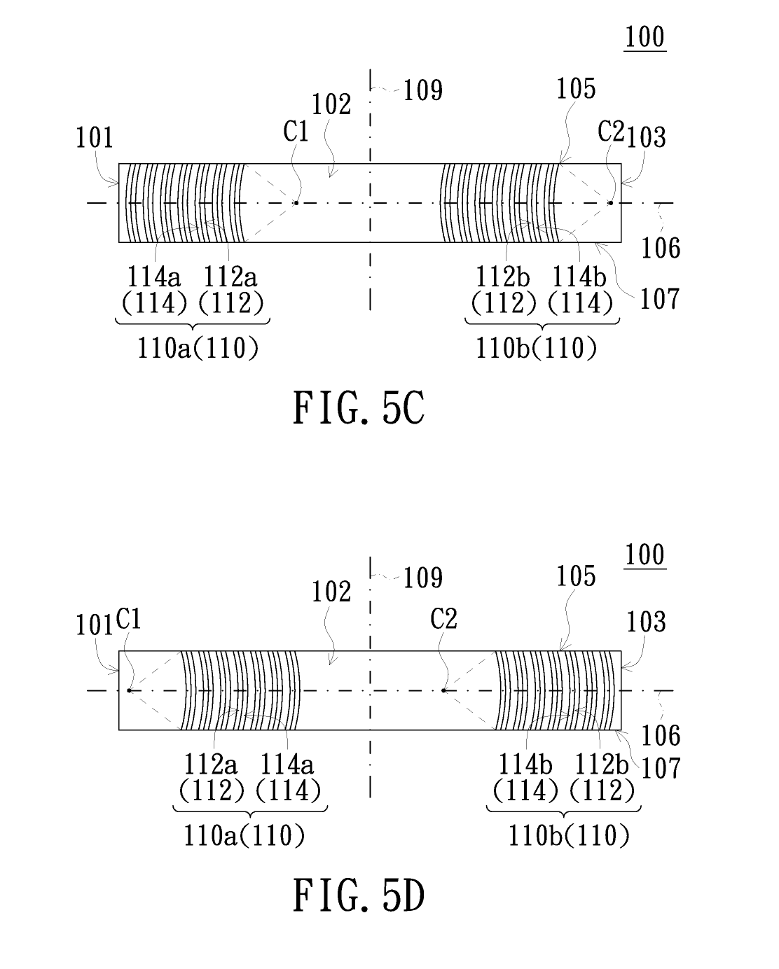

FIG. 5A is a side view schematic diagram showing the light incident surface 102 of the light guide plate 100 shown in FIG. 1. Referring to FIG. 5A, each of the elongated optical microstructures 110 according to this embodiment has an arc-shaped projection on the light incident surface 102. The arc-shaped projection is, but not limited to, a circular arc curve. The projection of the elongated optical microstructure 110 on the light incident surface 102 may be an ellipsoid, a paraboloid or any other curve, or a curve with several sections of different curvatures. In details, a projection of each first elongated optical microstructure 110a on the light incident surface 102 may, for example, have a curvature radius R1 and a first curvature center C1 (only one is shown in FIG. 5A), wherein each first elongated optical microstructure 110a is located between its first curvature center C1 and the first lateral surface 101. A projection of each second elongated optical microstructure 110b on the light incident surface 102 may, for example, have a curvature radius R2 and a second curvature center C2, wherein each second elongated optical microstructure 110b is located between its second curvature center C2 and the second lateral surface 103. The curvature radiuses R1 and R2 are, for example, greater than or equal to the thickness T of the light guide plate 100 such that the light beam can be uniformly diverged by the first elongated optical microstructures 110a and the second elongated optical microstructures 110b.

The first elongated optical microstructures 110a and the second elongated optical microstructures 110b according to this embodiment are, for example, mirror symmetric with each other with respect to the central axis 109 of the light incident surface 102, wherein the central axis 109 is an axis equidistant from the first lateral surface 101 and the second lateral surface 103 on the light incident surface 102. The projections of the first elongated optical microstructures 110a and the second elongated optical microstructures 110b on the light incident surface 102 are, for example, symmetric to a line connecting the first curvature center C1 and the second curvature center C2, respectively, so as to increase the light-emitting uniformity of the light guide plate 100. In details, the line connecting the first curvature center C1 and the second curvature center C2 may, for example, coincide with a bisector 106 of the light incident surface 102, wherein the bisector 106 is located between the light emitting surface 105 and the bottom surface 107 and is equidistant from the bottom surface 107 and the light emitting surface 105, the curvature radiuses R1 and R2 have the same length, and the first curvature center C1 and the second curvature center C2 are, for example, symmetric with respect to the central axis 109. In another embodiment as shown in FIG. 5B, each first elongated optical microstructure 110a may, but not limited to, be located between its first curvature center C1 and the second lateral surface 103, while each second elongated optical microstructure 110b may, but not limited to, be located between its second curvature center C2 and the first lateral surface 101.

The first elongated optical microstructures 110a and the second elongated optical microstructures 110b, as shown in FIGS. 5C and 5D, can be not mirror symmetric with each other with respect to the central axis 109. First, referring to FIG. 5C, the first elongated optical microstructures 110a are disposed between the first curvature center C1 and the first lateral surface 101, while the second elongated optical microstructures 110b are disposed between the second curvature center C2 and the first lateral surface 101. Next, referring to FIG. 5D, the first elongated optical microstructures 110a are located between the first curvature center C1 and the second lateral surface 103, while the second elongated optical microstructures 110b are located between the second curvature center C2 and the second lateral surface 103.

Moreover, in this embodiment, the line connecting the first curvature center C1 and the second curvature center C2 on the light incident surface 102 may, but not limited to, coincide with the bisector 106 of the light incident surface 102, wherein the bisector 106 is equidistant from the light emitting surface 105 and the bottom surface 107. However, in another embodiment, the line connecting the first curvature center C1 and the second curvature center C2 may not coincide with the bisector 106, and the projections of the first elongated optical microstructures 110a and the second elongated optical microstructures 110b on the light incident surface 102 can be not symmetric with respect to the line connecting the first curvature center C1 and the second curvature center C2 or the bisector 106.

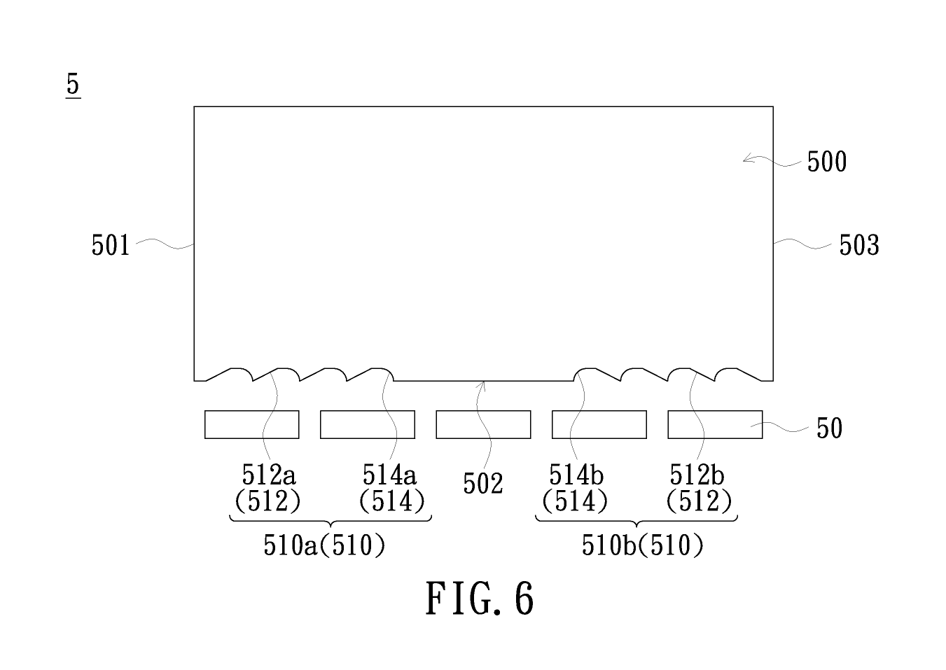

In aforementioned embodiments, each curved surface 114 of the elongated optical microstructure 110 may, but not limited to, protrude from the light guide plate 100 with respect to the light incident surface 102. According to another embodiment of the invention, as shown in FIG. 6, a backlight module 5 includes a light guide plate 500 and at least a light source 50, wherein the light source 50 is, for example, an LED disposed beside the light incident surface 502 of the light guide plate 500. The light guide plate 500 is similar to the light guide plate 100 according to the aforementioned embodiment, while the curved surface 514 of each elongated optical microstructure 510 is recessed in the light guide plate 500 with respect to the light incident surface 502.

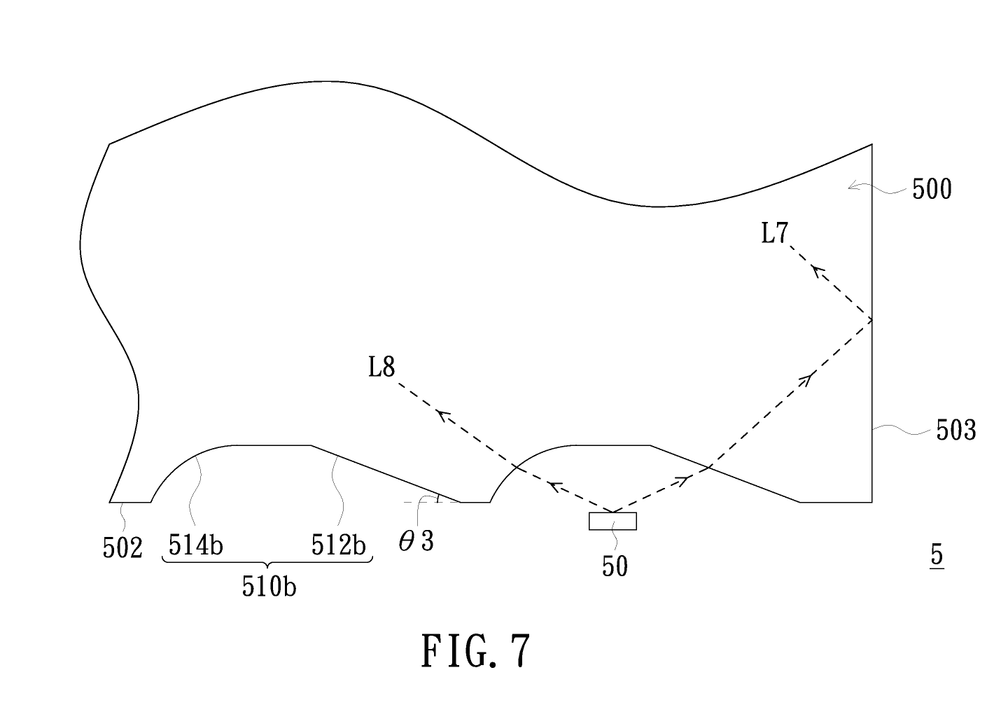

FIG. 7 is a partial top view schematic diagram showing the backlight module 5 shown in FIG. 6. For convenience for describing a light incident path, FIG. 7 shows only a part of the light guide plate 500 with second elongated optical microstructures 510b. Referring to FIG. 7, an included angle θ3 exists between the inclined surface 512b of the second elongated optical microstructure 510b and the light incident surface 502. The included angle θ3 is, for example, smaller than 45°, and preferably between 10° to 20°. The incident light beam L7 from the light source 50 enters the light guide plate 500 via the inclined surface 512b and transmits toward the second lateral surface 503 of the light guide plate 500 satisfies the total reflection condition, and thus can be reflected back inside the light guide plate 500 by the second lateral surface 503. Therefore, the side light leakage problem caused by the light beam L7 escaping out from the second lateral surface 503 can be reduced.

On the other hand, a refraction angle of another light beam L8 from the light source 50 incident to the light guide plate 500 via the curved surface 514b of the second elongated optical microstructure 510b is almost the same as the incident angle of the light beam L8. It can be seen that the divergence angle of the light beam L8 incident to the light guide plate 500 can be increased by the curved surface 514b, thereby the light emitting uniformity of the backlight module 5 can be ameliorated, and the generation of hot spots can be prevented.

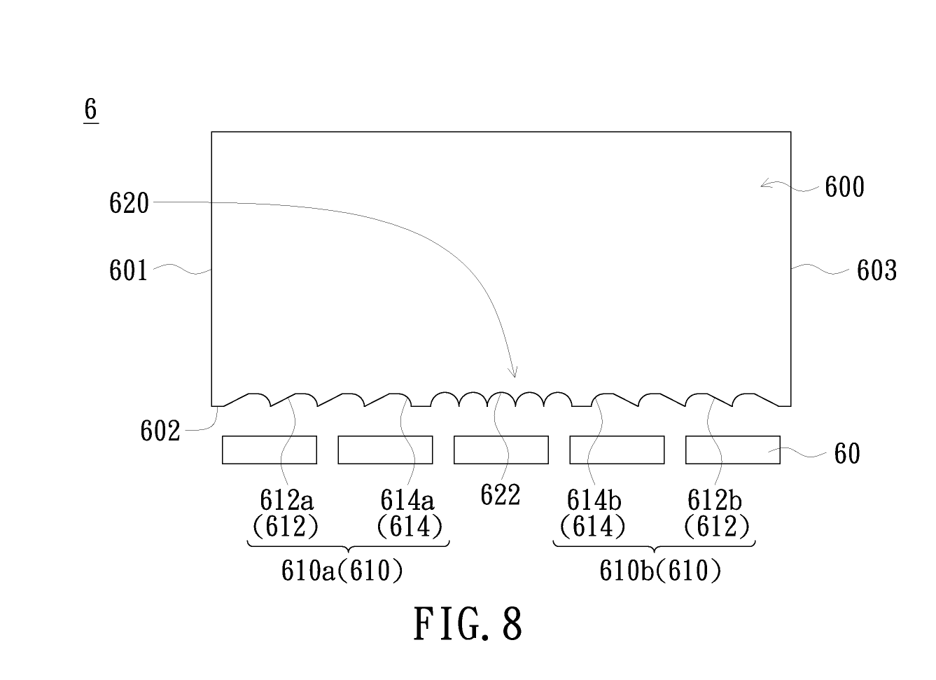

FIG. 8 is a top view schematic diagram showing a backlight module 6 according to another embodiment of the invention. Referring to FIG. 8, the backlight module 6 includes at least a light source 60 and a light guide plate 600. The light source 60 is disposed beside a light incident surface 602 of the light guide plate 600. The light source 60 is, for example, an LED or other point light source. Elongated optical microstructures 610 including first elongated optical microstructures 610a and second elongated optical microstructures 610b are disposed on the light incident surface 602 of the light guide plate 600. The positions for disposing the first and second elongated optical microstructures 610a, 610b can be determined according to positions prone to side light leakage in the existing backlight module. The light guide plate 600 is similar to the aforementioned light guide plate 500, but the light incident surface 602 of the light guide plate 600 has a plurality of light-diffusing microstructures 620 disposed between the first elongated optical microstructures 610a and the second elongated optical microstructures 610b. Each light-diffusing microstructure 620 is semi-cylindrical shaped and has a semi-cylindrical surface 622, which may, but not limited to, be recessed in the light guide plate 600 with respect to the light incident surface 602. In another embodiment, the semi-cylindrical surface 622 can protrude from the light guide plate 600 with respect to the light incident surface 602. A diffusion angle of the light beam incident to the light guide plate 600 via the light-diffusing microstructure 620 can be increased such that the generation of hot spots can be reduced.

In summary, the light guide plate and the backlight module of the invention may have at least one of the following advantages. The light incident surface of the light guide plate of the invention is disposed with the elongated optical microstructures, and each of which has an inclined surface and a curved surface at the same time. The inclined surface of the elongated optical microstructure can reduce a divergence angle of the light beam toward the lateral surface of the light guide plate to satisfy the total reflection condition, such that the light beam can be reflected back inside the light guide plate, and thus side light leakage can be reduced. On the other hand, the curved surface of the elongated optical microstructure of the light guide plate of the invention can enlarge a divergence angle of the light beam toward the center of the light guide plate, so that the light beam can be uniformly transmitted inside the light guide plate, and thus the generation of hot spots can be reduced. It can be seen that the light guide plate of the invention can not only reduce the occurrence probability of the side light leakage phenomenon so as to increase the light utilization rate of the backlight module, but also can reduce the generation of hot spots so as to ameliorate the light emitting uniformity of the backlight module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A light guide plate, comprising:
a light incident surface, a light emitting surface, a bottom surface, a first lateral surface, and a second lateral surface,
wherein the light incident surface has a plurality of elongated optical microstructures, each of the elongated optical microstructures has a first end and a second end, the first end is connected to the light emitting surface, the second end is connected to the bottom surface, each of the elongated optical microstructures has an arc-shaped projection on the light incident surface, each of the elongated optical microstructures has an inclined surface and a curved surface connected with each other.

2. The light guide plate as claimed in claim 1, wherein the curved surface of each elongated optical microstructure protrudes from the light guide plate with respect to the light incident surface.

3. The light guide plate as claimed in claim 1, wherein the curved surface of each elongated optical microstructure is recessed in the light guide plate with respect to the light incident surface.

4. The light guide plate as claimed in claim 1, wherein the arc-shaped projection on the light incident surface of each elongated optical microstructure has a curvature radius, and the curvature radius is greater than or equal to a thickness of the light guide plate.

5. The light guide plate as claimed in claim 1, wherein the light incident surface is connected to the first lateral surface and the second lateral surface respectively, the elongated optical microstructures comprise at least a first elongated optical microstructure and at least a second elongated optical microstructure, the first elongated optical microstructure is disposed near the first lateral surface, and the second elongated optical microstructure is disposed near the second lateral surface.

6. The light guide plate as claimed in claim 5, wherein the light incident surface has a central axis between the first lateral surface and the second lateral surface, and the central axis is equidistant from the first lateral surface and the second lateral surface, the first elongated optical microstructure and the second elongated optical microstructure are mirror symmetric with each other with respect to the central axis.

7. The light guide plate as claimed in claim 5, wherein the inclined surface of the first elongated optical microstructure has a normal line direction exiting the inclined surface away from the first lateral surface, and the inclined surface of the second elongated optical microstructure has a normal line direction exiting the inclined surface away from the second lateral surface.

8. The light guide plate as claimed in claim 5, wherein the arc-shaped projection of the first elongated optical microstructure has a first curvature center, and the first elongated optical microstructure is located between the first curvature center and the first lateral surface.

9. The light guide plate as claimed in claim 5, wherein the arc-shaped projection of the second elongated optical microstructure has a second curvature center, and the second elongated optical microstructure is located between the second curvature center and the second lateral surface.

10. The light guide plate as claimed in claim 5, wherein the arc-shaped projection of the first elongated optical microstructure has a first curvature center, and the first elongated optical microstructure is located between the first curvature center and the second lateral surface.

11. The light guide plate as claimed in claim 5, wherein the arc-shaped projection of the second elongated optical microstructure has a second curvature center, and the second elongated optical microstructure is located between the second curvature center and the first lateral surface.

12. The light guide plate as claimed in claim 5, wherein the light incident surface further comprises a plurality of light-diffusing microstructures disposed between the first elongated optical microstructure and the second elongated optical microstructure, each light-diffusing microstructure is semi-cylindrical shaped and comprises a semi-cylindrical surface, and the semi-cylindrical surface protrudes from the light guide plate with respect to the light incident surface.

13. The light guide plate as claimed in claim 5, wherein the light incident surface further comprises a plurality of light-diffusing microstructures disposed between the first elongated optical microstructure and the second elongated optical microstructure, each light-diffusing microstructure is semi-cylindrical shaped and comprises a semi-cylindrical surface, and the semi-cylindrical surface is recessed in the light guide plate with respect to the light incident surface.

14. The light guide plate as claimed in claim 5, wherein the light incident surface comprises a bisector located between the light emitting surface and the bottom surface, the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center coincides with the bisector.

15. The light guide plate as claimed in claim 5, wherein the light incident surface comprises a bisector located between the light emitting surface and the bottom surface, and the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center does not coincide with the bisector.

16. A backlight module, comprising:
at least a light source; and
a light guide plate, comprising a light incident surface, a light emitting surface, a bottom surface, a first lateral surface, and a second lateral surface, wherein the light source is disposed beside the light incident surface, the light incident surface has a plurality of elongated optical microstructures, each of the elongated optical microstructures has a first end and a second end, the first end is connected to the light emitting surface, the second end is connected to the bottom surface, each of the elongated optical microstructures has an arc-shaped projection on the light incident surface, each of the elongated optical microstructures has an inclined surface and a curved surface connected with each other.

17. The backlight module as claimed in claim 16, wherein the curved surface of each elongated optical microstructure protrudes from the light guide plate with respect to the light incident surface.

18. The backlight module as claimed in claim 16, wherein the curved surface of each elongated optical microstructure is recessed in the light guide plate with respect to the light incident surface.

19. The backlight module as claimed in claim 16, wherein the arc-shaped projection on the light incident surface of each elongated optical microstructure has a curvature radius, and the curvature radius is greater than or equal to thickness of the light guide plate.

20. The backlight module as claimed in claim 16, wherein the light guide plate further comprises a plurality of light guide microstructures disposed on the bottom surface, the light guide microstructures are in a configuration of V-shaped grooves, semi-cylindrical grooves, spherical depressions, pyramidal depressions, printed dots or a combination of the above configurations.

21. The backlight module as claimed in claim 16, wherein the light incident surface is connected to the first lateral surface and the second lateral surface respectively, the elongated optical microstructures comprise at least a first elongated optical microstructure and at least a second elongated optical microstructure, the first elongated optical microstructure is disposed near the first lateral surface, and the second elongated optical microstructure is disposed near the second lateral surface.

22. The backlight module as claimed in claim 21, wherein the light incident surface has a central axis between the first lateral surface and the second lateral surface, and the central axis is equidistant from the first lateral surface and the second lateral surface, the first elongated optical microstructure and the second elongated optical microstructure are mirror symmetric with each other with respect to the central axis.

23. The backlight module as claimed in claim 21, wherein the inclined surface of the first elongated optical microstructure has a normal line direction exiting the inclined surface away from the first lateral surface, and the inclined surface of the second elongated optical microstructure has a normal line direction exiting the inclined surface away from the second lateral surface

24. The backlight module as claimed in claim 21, wherein the arc-shaped projection of the first elongated optical microstructure has a first curvature center, and the first elongated optical microstructure is located between the first curvature center and the first lateral surface.

25. The backlight module as claimed in claim 21, wherein the arc-shaped projection of the second elongated optical microstructure has a second curvature center, and the second elongated optical microstructure is located between the second curvature center and the second lateral surface.

26. The backlight module as claimed in claim 21, wherein the arc-shaped projection of the first elongated optical microstructure has a first curvature center, and the first elongated optical microstructure is located between the first curvature center and the second lateral surface.

27. The backlight module as claimed in claim 21, wherein the arc-shaped projection of the second elongated optical microstructure has a second curvature center, and the second elongated optical microstructure is located between the second curvature center and the first lateral surface.

28. The backlight module as claimed in claim 21, wherein the light incident surface further comprises a plurality of light-diffusing microstructures disposed between the first elongated optical microstructures and the second elongated optical microstructures, each light-diffusing microstructure is semi-cylindrical shaped and comprises a semi-cylindrical surface, and the semi-cylindrical surface protrudes from the light guide plate with respect to the light incident surface.

29. The backlight module as claimed in claim 21, wherein the light incident surface further comprises a plurality of light-diffusing microstructures disposed between the first elongated optical microstructures and the second elongated optical microstructures, each light-diffusing microstructure is semi-cylindrical shaped and comprises a semi-cylindrical surface, and the semi-cylindrical surface is recessed in the light guide plate with respect to the light incident surface.

30. The backlight module as claimed in claim 21, wherein the light incident surface comprises a bisector located between the light emitting surface and the bottom surface, the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center coincides with the bisector.

31. The backlight module as claimed in claim 21, wherein the light incident surface comprises a bisector located between the light emitting surface and the bottom surface, the bisector is equidistant from the light emitting surface and the bottom surface, the arc-shaped projection of the first elongated optical microstructure has a first curvature center, the arc-shaped projection of the second elongated optical microstructure has a second curvature center, and a line connecting the first curvature center and the second curvature center does not coincide with the bisector.
